(19) United States
(12) Patent Application Publication
(10) Pub. No.: US 2006/0134295 A1
(43) Pub. Date: Jun. 22, 2006

(54) High-fiber, high-protein pasta and noodle products

(76) Inventors: Clodualdo C. Maningat, Platte City, MO (US); Sukh D. Bassi, Atchison, KS (US); Kyungsoo Woo, Shawnee, KS (US)

Correspondence Address: LATHROP & GAGE LC, 4845 PEARL EAST CIRCLE, SUITE 300, BOULDER, CO, 80301, US

(21) Appl. No.: 11/222,625

(22) Filed: Sep. 9, 2005

Related U.S. Application Data
(60) Provisional application No. 60/608,188, filed on Sep. 9, 2004.

(51) Int. Cl. A23L 1/16

(52) U.S. Cl. 426/557

(57) ABSTRACT

The present invention generally pertains to new and useful pasta and noodle products with high-fiber and high-protein contents. The pasta and noodle products are made from non-traditional materials comprising a synthetic flour mixture. The synthetic flour mixture includes a resistant starch, having a total dietary fiber content between about 10% and about 70%, and a protein source.

### RELATED APPLICATIONS

This application claims the benefit of priority to U.S. provisional patent application Ser. No. 60/608,188, filed Sep. 9, 2004, which is incorporated herein by reference.

### FIELD OF THE INVENTION

The present invention generally pertains to new and useful pasta and noodle products with high-fiber and high-protein contents, and method for making the same. The pasta and noodle products are made from non-traditional materials comprising a synthetic flour mixture.

### BACKGROUND

The Expert Committee on Dietary Fiber Definition of the American Association of Cereal Chemists defines dietary fiber as “the edible parts of plants or analogous carbohydrates that are resistant to digestion and absorption in the human small intestine with complete or partial fermentation in the large intestine. Dietary fiber includes polysaccharides, oligosaccharides, lignin, and associated plant substances. Dietary fibers promote beneficial physiological effects including Taxation, and/or blood cholesterol attenuation, and/or blood glucose attenuation.” Examples of sources of dietary fiber include whole grains, cereal brans, hydrocolloids (gums), polydextrose, inulin, oligofructose, and soy fiber. Resistant starch, which is defined as the “sum of starch and products of starch degradation not absorbed in the small intestines of healthy individuals”, is included in the definition of dietary fiber under analogous carbohydrates. Analogous carbohydrates are materials not necessarily intrinsic to a part of a plant as consumed, but which exhibit the digestion and fermentation properties of fiber.

Fiber was once viewed as an undesirable entity that was processed out of foods; however, it is now the practice to retain or add fiber to foodstuffs. This change in attitude is due to the hypothesis that certain diseases in Western civilization are due to the failure of the population to consume adequate amounts of fiber during early life. Diseases and disorders that may result from inadequate fiber in the diet are appendicitis, atheroma, colon cancer, constipation, coronary thrombosis, dental caries, deep-vein thrombosis, diabetes, diverticulitis, gallstones, hemorrhoids, hiatus hernia, ischemic heart disease, peptic ulcer, polyps of the bowel, and varicose veins.

In the late 1990's and in the early years of the 21^{st} century, a revival of interest in dietary fiber surfaced due to the popularity of several low-carbohydrate diet plans, which address the rising statistics on overweight conditions or obesity among the world's population. The primary causes of escalating obesity rates are increased per capita caloric consumption and larger portion sizes, along with a lack of adequate physical activity. Conditions that arise as a result of obesity are type II diabetes, cardiovascular disease, osteoarthritis, and certain cancers.

Initiatives that may help curb the obesity problem include healthier food programs, exercise plans, and dietary guidelines. Several options for weight management would include practices that promote the following: increased body metabolism, increased satiety, reduced caloric intake, reduced glycemic index, and consumption of fiber-enriched foods.

In many parts of the world, consumption of pasta and noodles is significant. Fiber-enriched pasta and noodles can help address the growing obesity and overweight problems. Many attempts have been made to enrich the fiber level of pasta and noodles by formulating products with whole grains, cereal brans, hydrocolloids (gums), or other fiber sources. While this approach has provided high-fiber products, the resulting pasta or noodle does not have the typical appearance, absorption, handling characteristics, texture, or flavor of traditional products. For example, if whole grain or cereal bran is used, the resulting noodle or pasta product will have a specked appearance and will have greater susceptibility to rancidity development due to the potential deterioration of fat that is normally present in high amounts in whole grains and cereal brans. In addition, formulating plain sources of dietary fiber without compensating for protein content will result in pasta or noodle dough with poor handling and machining properties.

### SUMMARY

The present invention overcomes the above problems and provides high-fiber, high-protein pasta and noodle products which exhibit comparable handling and processing properties, appearance, texture, flavor and cooking characteristics to those of traditional pasta and noodle products.

In one aspect, a high-fiber, high-protein pasta includes a resistant starch having a total dietary fiber content between about 10% and about 70%, a protein source selected from the group consisting of gliadin, glutenin, a wheat protein isolate, a wheat protein concentrate, a devitalized wheat gluten, a fractionated wheat protein product, a deamidated wheat gluten product, a hydrolyzed wheat protein product, or a mixture thereof, and semolina.

In one aspect, a high-fiber, high-protein noodle includes a resistant starch having a total dietary fiber content between about 10% and about 70%, a protein source selected from the group consisting of gliadin, glutenin, a wheat protein isolate, a wheat protein concentrate, a devitalized wheat gluten, a fractionated wheat protein product, a deamidated wheat gluten product, a hydrolyzed wheat protein product, or a mixture thereof, and wheat flour.

In one aspect, improved methods of producing pasta or noodles include substituting a synthetic flour mixture for a portion of semolina or wheat flour, respectively.

### DETAILED DESCRIPTION

As used herein, the term “synthetic flour mixture” refers to a composition including a composite blend of a resistant starch source and a protein source. The protein source may be derived from wheat and selected from the group consisting of gliadin, glutenin, a wheat protein isolate, a wheat protein concentrate, a devitalized wheat gluten, a fractionated wheat protein product, a deamidated wheat gluten product, a hydrolyzed wheat protein product, and mixtures thereof. The synthetic flour mixture may be used alone or added to semolina or wheat flour during pasta or noodle processing, respectively.

It will be understood that semolina is a coarse grain particle obtained from the milling of durum wheat. Semolina, especially wheat semolina, is frequently used to make pasta products, while noodles are typically created from wheat flour recipes.

Wheat protein isolates are generally derived from wheat gluten by taking advantage of gluten's solubility at alkaline or acidic pH values. Wheat gluten is soluble in aqueous solutions with an acidic or alkaline pH and exhibits a classical “U-shaped” solubility curve with a minimum solubility or isoelectric point at pH 6.5-7.0. By dissolving the gluten, proteins can be separated from non-protein components by processes like filtration, centrifugation, or membrane processing followed by spray drying. Alternatively, wet gluten from wet processing of wheat flour can be repeatedly kneaded, water washed, and dewatered to get rid of contaminating starch and other non-protein components, and subsequently flash dried. These techniques yield a wheat protein isolate product with elevated protein content, at least about 85% by weight, more preferably at least about 90% by weight (on an N×6.25, dry basis). Wheat protein isolates in general are less elastic but more extensible than wheat gluten. Examples of preferred wheat protein isolates include Arise™ 3000, Arise™ 5000, Arise™ 6000, Pasta Power, and Arise™ 8000 and their blends available from MGP Ingredients, Inc., Atchison, Kans.

Wheat protein concentrates are proteinaceous compositions which preferably have protein contents of at least about 70% by weight, and preferably at least about 82% by weight (N×6.25, dry basis). Wheat protein concentrates may be of different varieties manufactured by a number of different methods. Vital wheat gluten is one type of wheat protein concentrate that has a protein content of at least about 82% by weight (N×6.25, dry basis). Vital wheat gluten is a viscoelastic protein manufactured by a flash drying method. Additional types of wheat protein concentrates are manufactured by dispersing wet gluten in an ammonia solution or dilute organic acids with or without reducing agents followed by spray drying. These wheat protein concentrates in general exhibit lesser viscoelastic properties than vital wheat gluten and tend to be more extensible. Examples of the latter type of wheat protein concentrates include FP100, FP 200, FP 300, FP 500, FP 600, and FP 800 available from MGP Ingredients.

Wheat gluten can be devitalized (or rendered non-vital) by the application of moisture, heat, pressure, shear, enzymes, and/or chemicals. Devitalized gluten is characterized by denaturation of proteins where structural changes occur and certain bonds are formed or broken resulting in a product that is non-cohesive and lacks viscoelasticity. Typical processing equipment used to carry out this devitalization includes extruders, jet-cookers, drum-driers, and boiling water tanks. For example, wheat gluten may undergo extrusion processing to produce a texturized product which does not exhibit the same viscoelastic properties of typical wheat gluten. In other words, the devitalized gluten does not form a rubbery and/or extensible dough when hydrated. Devitalized wheat gluten preferably comprises at least about 60% by weight protein, and more preferably at least about 70% by weight (N×6.25, dry basis). Examples of devitalized wheat gluten for use with the present invention are Wheatex™ 16, Wheatex™ 120, Wheatex™ 240, Wheatex™ 751, Wheatex™ 1501, Wheatex™ 2120, Wheatex™ 2240, Wheatex™ 2400, Wheatex™ 3000, Wheatex™ 6000, Wheatex™ 6500, and Wheatex™ RediShred 65 available from MGP Ingredients. These Wheatex™ products may contain malt or caramel.

Wheat gluten is a binary mixture of gliadin and glutenin. These components can be separated by alcohol fractionation or by using a non-alcoholic process (as disclosed in U.S. Pat. No. 5,610,277) employing the use of organic acids. Gliadin is soluble in 60-70% alcohol and comprises monomeric proteins with molecular weights ranging from 30,000 to 50,000 daltons. These proteins are classified as alpha-, beta-, gamma-, and omega-gliadins depending on their mobility during electrophoresis at low pH. Gliadin is primarily responsible for the extensible properties of wheat gluten. Glutenin is the alcohol insoluble fraction and contributes primarily to the elastic or rubbery properties of wheat gluten. Glutenin is a polymeric protein stabilized with inter-chain disulfide bonds and made up of high-molecular weight and low molecular weight subunits. Generally, glutenin exhibits a molecular weight exceeding one million daltons. Preferred fractionated wheat protein products comprise at least about 85% by weight protein, and preferably at least about 90% by weight for gliadin and at least about 80% by weight for glutenin, all proteins expressed on N×6.25, dry basis.

Deamidated wheat protein products may be manufactured according to a number of techniques. One such technique is to treat wheat gluten with low concentrations of hydrochloric acid at elevated temperatures to deamidate or convert glutamine and asparagine amino acid residues in the protein into glutamic acid and aspartic acid, respectively. Other techniques include treating wheat gluten with an alkaline solution or with enzymes such as transglutaminase. This modification causes a shift in the isoelectric point of the protein from about neutral pH to about pH 4. This signifies that the deamidated wheat protein product is least soluble at pH 4, but is soluble at neutral pH. Deamidated wheat protein products preferably comprise at least about 75% by weight protein, and more preferably at least about 83% by weight (N×6.25, dry basis). An example of a deamidated wheat protein product for use with the present invention is WPI 2100 available from MGP Ingredients.

Hydrolyzed wheat protein products are manufactured by reacting an aqueous dispersion of wheat gluten with food-grade proteases having endo- and/or exo-activities to hydrolyze the proteins into a mixture of low-molecular weight peptides and polypeptides. The hydrolyzed mixture is then dried. Hydrolyzed wheat protein products generally exhibit a water solubility of at least about 50%. Hydrolyzed wheat protein products preferably have protein contents of at least about 70% by weight, more preferably at least about 82% by weight (6.25×N, dry basis). Examples of hydrolyzed wheat protein products for use in the present invention include FP 400, FP 700, HWG 2009, PG 30, FP 1000, and FP 1000 Isolate, all available from MGP Ingredients.

Other useful proteinaceous ingredients include soy protein concentrate, soy protein isolate, whey protein, sodium caseinate, nonfat dry milk, dried egg whites, and mixtures thereof.

Pasta and noodle products made in accordance with the present invention comprise an amount of resistant starch. The resistant starch may be used in place of at least a portion of the flour which comprises traditional pasta and noodle products, thereby effectively reducing the “net” carbohydrate total of the product. As explained in further detail below, resistant starch is generally not digestible thereby exhibiting characteristics which are similar to those of dietary fiber.

In 1987 Englyst and Cummings at the MRC Dunn Clinical Nutrition Center in Cambridge, UK, proposed a classification of starch based on its likely digestive properties in vivo. They also devised in vitro assay methods to mimic the various digestive properties of starch. Three classes of dietary starch were proposed:

Rapidly Digestible Starch (RDS). RDS is likely to be rapidly digested in the human small intestine; examples include freshly cooked rice and potato, and some instant breakfast cereals.

Slowly Digestible Starch (SDS). SDS is likely to be slowly yet completely digested in the small intestine; examples include raw cereal starch and cooked pasta.

Resistant Starch (RS). RS is likely to resist digestion in the small intestine. RS is thus defined as the sum of starch and starch degradation products not likely to be absorbed in the small intestine of healthy individuals. RS can be subdivided into four categories depending on the cause of resistance (Englyst et al., Eur. J. Clin. Nutr. 46 (suppl 2):S33, 1992; Eerlingen et al., Cereal Chem. 70:339, 1993).

RS₁. Physically inaccessible starch due to entrapment of granules within a protein matrix or within a plant cell wall, such as in partially milled grain or legumes after cooling.

RS₂. Raw starch granules, such as those from potato or green banana, that resist digestion by alpha-amylase, possibly because those granules lack micropores through their surface.

RS₃. Retrograded amylose formed by heat/moisture treatment of starch or starch foods, such as occurs in cooked/cooled potato and corn flake.

RS₄. Chemically modified starches, such as acetylated, hydroxypropylated, or cross-linked starches that resist digestion by alpha-amylase. Those modified starches would be detected by the in vitro assay of RS. However, some RS₄ may not be fermented in the colon.

RS₁, RS₂, RS₃ are physically modified forms of starch and become accessible to alpha-amylase digestion upon solubilization in sodium hydroxide or dimethyl sulfoxide. RS₄ that is chemically substituted remains resistant to alpha-amylase digestion even if dissolved. RS₄ produced by cross-linking would resist dissolution.

Highly cross-linked wheat starches belonging to the RS₄ category may be manufactured by processes disclosed in U.S. Pat. No. 5,855,946. These involve the reaction of plant starch with sodium trimetaphosphate (STMP), sodium tripolyphosphate (STPP), or mixtures thereof. Typical total dietary fiber content (measured by AOAC Method 991.43) of these RS₄ products can range from 10% to greater than 70%.

Useful plant starches include those made from wheat, potato, corn, tapioca, rice, sago, sweet potato, mungbean, oat, barley, rye, triticale, sorghum, banana, and other botanical sources, including waxy, partial waxy, and high-amylose variants (“waxy” being intended to include at least 95% by weight amylopectin and high amylose at least about 40% by weight amylose). Chemically, physically or genetically modified forms of these starches can also be used. Modification techniques include 1) treatment with chemicals and/or enzymes according to 21 CFR 172.892; 2) physical associations such as retrogradation (recrystallization), heat moisture treatment, partial gelatinization, annealing, and roasting; 3) genetic modifications including gene or chromosome engineering, such as cross-breeding, translocation, inversion and transformation; and 4) combinations of the above.

Examples of preferred RS₄ products for use with the present invention are the Fibersym® resistant starch series manufactured by MGP Ingredients of Atchison, Kans. using processes disclosed in U.S. Pat. No. 5,855,946. The series consists of Fibersym 70 (wheat-based), Fibersym 70 HA (high-amylose corn based) and Fibersym 80 ST (potato-based). Each is made by reacting the starch in an aqueous slurry containing a mixture of STMP, STPP, and sodium sulfate at a basic pH (approximately 11) with moderate heating. Generally speaking, each of these resistant starches has a total dietary fiber content (measured by AOAC Method 991.43) of 70% or higher.

### EXAMPLES

The following examples set forth preferred products in accordance with the present invention. It is to be understood, however, that these examples are provided by way of illustration and nothing therein should be taken as a limitation upon the overall scope of the invention.

Procedures

Spaghetti Processing

The procedure for making spaghetti includes a) blending all the ingredients using a cross-flow blender, b) adding water to bring moisture content to about 32%, c) extruding the resulting hydrated material in a DeMaCo semi-commercial laboratory extruder using the following conditions: extrusion temperature, 45° C.; mixing chamber vacuum, 46 cm of Hg; auger extrusion speed, 25 rpm; and target amperes, 2, and d) drying the spaghetti using a high-temperature (70° C.) drying cycle.

Noodle Processing

Three types of noodles, namely white salted noodle, chuka-men noodle, and instant fried noodle, were processed using the recipes shown in Tables 11, 14 and 17. A synthetic flour mixture comprising an 84:16 blend of Fibersym™ 70 (resistant wheat starch) and Pasta Power™ (wheat protein isolate) was used to replace about 10%, 30%, 50%, or 70% of the wheat flour used in traditional recipes. The dry ingredients were combined and water was added at levels of between about 28-38 parts for every 100 parts of the wheat flour and synthetic flour mixture. Mixing, compressing, compounding, and sheeting operations were performed. The noodle sheet was slit and cut for white salted and chuka-men noodles. In the case of instant fried noodles, the noodle sheet was slit, waved, steamed, and fried.

Color Determination

Spaghetti and noodle color were determined using a Minolta chromameter, a Hunter Tristimulus Colorimeter, and/or a CIE colorimeter. Results are reported as “L, a, and b”, where L is the measure of light in the sample ranging from 0.0 as black to 100.0 as white; a is a measure of the amount of green to red in the sample, −60.0 represents pure green and +60.0 represents pure red; b is a measure of the amount of blue to yellow in the sample, −60.0 represents pure blue and +60.0 represents pure yellow. The color score is a composite index based on the L, a, and b values, where, for example, a may be lightly weighted—or left out of the index—and b may be heavily weighted because of the importance of yellow pigmentation in pasta and noodle products. Color scores between about 6-9 are preferred for spaghetti, with color scores between about 7-9 being more preferred, and color scores between about 8-9 being most preferred.

Cooking Test

For the cooking test, 10 g of spaghetti were placed in 300 ml of boiling distilled water for 12 min, drained and cooled, and then weighed for cooked weight. Cooked weight is optimally about 3 times greater than pre-cooked weight and at least about 2 times greater than pre-cooked weight. Cooking loss was evaluated by determining percent solids in cooking water following drying at 110° C. overnight in a convection oven. Cooked firmness was determined as the work required to cut through 5 strands of spaghetti using a TA-XT2 Texture Analyzer, where a firmness of greater than six was preferred.

Optimum Cooking Time

Optimum cooking time was determined by placing 10 g of spaghetti (5 cm long) in 300 ml of boiling distilled water. The optimum cooking time was designated as the time at which the white core was no longer observable when the boiled product was pressed between two transparent glass plates. An optimum cooking time typically produces a product having a cooked weight greater than twice the dry pasta weight, with solids in the cooking water, and a firmness of greater than 6

### Example 1

Composition of Synthetic Flour Mixture for Spaghetti Making

| Product Code | Synthetic Flour Mixture | Semolina |
|---|---|---|
| Control | 0% | 100% |
| 101 | 20% vital wheat gluten, 80% resistant | 0% |
| | starch | |
| 102 | 20% wheat protein concentrate, 80% | 0% |
| | resistant starch | |
| 103 | 20% wheat protein concentrate, 80% | 0% |
| | resistant starch | |
| 104 | 20% wheat protein concentrate, 80% | 0% |
| | resistant starch | |
| 105 | 20% wheat protein concentrate, 80% | 0% |
| | resistant starch | |
| 106 | 20% wheat protein isolate, 80% | 0% |
| | resistant starch | |
| 107 | 20% wheat protein isolate, 80% | 0% |
| | resistant starch | |
| 108 | 20% wheat protein isolate, 80% | 0% |
| | resistant starch | |
| 109 | 20% gliadin, 80% resistant starch | 0% |
| 110 | 20% glutenin, 80% resistant starch | 0% |

The resistant starch used in each of these experiments was MGPI Fibersym 70. The wheat protein concentrate used in experiment 102 was MGPI FP 300. The wheat protein concentrate used in experiment 103 was MGPI FP 500 (which is more extensible than FP 300). The wheat protein concentrate used in experiment 104 was MGPI FP 600 (which is more extensible than FP 500). The wheat protein concentrate used in experiment 105 was MGPI FP 800 (which is more extensible than FP 500 but less extensible than FP 600).

The wheat protein isolate used in experiment 106 was MGPI Arise 3000. The wheat protein isolate used in experiment 107 was MGPI Arise 5000(which is more extensible than Arise 3000). The wheat protein isolate used in experiment 108 was MGPI Arise 6000 (which is more extensible than Arise 3000 but less extensible than Arise 5000).

TABLE 1
Spaghetti Color

| Product | Hunter | | | Color | CIE | | |
|---|---|---|---|---|---|---|---|
| Code | L | a | b | Score | L | a | b |
| Semolina | 53.91 | 3.93 | 23.90 | 7.5 | 60.84 | 4.61 | 39.95 |
| (Control) | | | | | | | |
| 101 | 58.22 | 3.65 | 16.45 | 5.0 | 64.88 | 4.19 | 23.18 |
| 102 | 57.68 | 4.03 | 17.04 | 5.0 | 64.38 | 4.64 | 24.32 |
| 103 | 58.61 | 3.71 | 16.59 | 5.0 | 65.24 | 4.25 | 23.32 |
| 104 | 58.62 | 3.85 | 18.91 | 6.0 | 65.25 | 4.41 | 27.43 |
| 105 | 56.90 | 4.28 | 18.96 | 6.0 | 63.65 | 4.94 | 28.02 |
| 106 | 55.89 | 3.92 | 18.19 | 6.0 | 62.71 | 4.55 | 26.85 |
| 107 | 65.35 | 2.42 | 17.14 | 6.0 | 71.35 | 2.70 | 22.88 |
| 110 | 50.47 | 4.26 | 16.69 | 4.5 | 57.53 | 5.10 | 25.60 |

The control sample, which contained 100% semolina, produced a color score in the desirable range. Other compositions containing 80% Fibersym (resistant starch) with various protein sources produced slightly less desirable color scores.

### Example 2

Composition of Synthetic Flour Mixture and
Semolina for Spaghetti Making

| Product Code | Synthetic Flour Mixture | Semolina |
|---|---|---|
| Control | 0% | 100% |
| 171 | 1.8% wheat protein isolate, 8.9% | 89.3% |
| | resistant starch | |
| 172 | 2.7% wheat protein isolate, 8.8% | 88.5% |
| | resistant starch | |
| 173 | 3.5% wheat protein isolate, 8.8% | 87.7% |
| | resistant starch | |
| 174 | 1.7% wheat protein isolate, 12.8% | 85.5% |
| | resistant starch | |
| 175 | 2.5% wheat protein isolate, 12.7% | 84.8% |
| | resistant starch | |
| 176 | 3.4% wheat protein isolate, 12.6% | 84.0% |
| | resistant starch | |
| 177 | 1.8% vital wheat gluten, 8.9% | 89.3% |
| | resistant starch | |
| 178 | 3.5% vital wheat gluten, 8.8% | 87.7% |
| | resistant starch | |
| 179 | 1.7% vital wheat gluten, 12.8% | 85.5% |
| | resistant starch | |
| 180 | 3.4% vital wheat gluten, 12.6% | 84.0% |
| | resistant starch | |

The resistant starch used in each of these experiments was MGPI Fibersym 70. The wheat protein isolate used in these experiments was MGPI Pasta Power (which is as extensible as Arise 6000).

TABLE 2
Spaghetti Color

| Product | Hunter | | | Color | CIE | | |
|---|---|---|---|---|---|---|---|
| Code | L | a | b | Score | L | a | b |
| Control | 53.91 | 3.93 | 23.90 | 7.5 | 60.84 | 4.61 | 39.95 |
| 171 | 54.90 | 3.85 | 24.07 | 8.0 | 61.78 | 4.50 | 39.77 |
| 172 | 54.64 | 3.82 | 24.43 | 8.0 | 61.53 | 4.48 | 40.85 |
| 173 | 53.66 | 4.28 | 23.69 | 7.5 | 60.60 | 5.03 | 39.58 |
| 174 | 55.19 | 3.48 | 24.12 | 8.5 | 62.05 | 4.07 | 39.71 |
| 175 | 54.84 | 3.40 | 24.14 | 8.0 | 61.72 | 3.98 | 40.00 |
| 176 | 54.30 | 3.92 | 24.01 | 8.0 | 61.20 | 4.60 | 39.98 |
| 177 | 54.21 | 3.73 | 24.00 | 8.0 | 61.13 | 4.37 | 40.00 |
| 178 | 53.56 | 4.09 | 23.69 | 7.5 | 60.50 | 4.82 | 39.64 |
| 179 | 55.21 | 3.51 | 23.91 | 7.5 | 62.07 | 4.10 | 39.22 |
| 180 | 53.69 | 3.81 | 23.30 | 7.5 | 60.63 | 4.49 | 38.61 |

Acceptable color scores between about 7.5-8 were obtained when between about 85-90% of the dry ingredients comprised semolina, with a remaining 10-15% of the dry ingredients being formed by a synthetic flour mixture.

TABLE 3
Cooking Properties of Spaghetti

| | | | Cooked |
|---|---|---|---|
| | | | firmness, |
| Product Code | Cooking loss, % | Cooked weight, g | gcm |
| Control | 4.4 | 30.6 | 6.0 |
| 171 | 4.6 | 29.4 | 6.4 |
| 172 | 4.4 | 28.9 | 6.5 |
| 173 | 4.7 | 28.5 | 6.7 |
| 174 | 4.5 | 28.9 | 6.0 |
| 175 | 4.3 | 28.3 | 6.5 |
| 176 | 3.7 | 28.9 | 6.4 |
| 177 | 4.7 | 29.4 | 6.1 |
| 178 | 2.4 | 28.3 | 6.8 |
| 179 | 2.1 | 30.1 | 5.7 |
| 180 | 2.2 | 28.8 | 5.6 |

Cooked weights of approximately 30 g were obtained along with firmness values of about 5.5-7. All of the samples tested displayed properties consistent with those of traditional pasta products.

### Example 3

Composition of Synthetic Flour Mixture and
Semolina for Spaghetti Making

| Product Code | Synthetic Flour Mixture | Semolina |
|---|---|---|
| Control | 0% | 100% |
| P-500 | 15% wheat protein isolate, 60% | 25% |
| | resistant starch | |
| P-600 | 14% wheat protein isolate, 56% | 30% |
| | resistant starch | |
| P-700 | 13% wheat protein isolate, 52% | 35% |
| | resistant starch | |
| P-800 | 12% wheat protein isolate, 48% | 40% |
| | resistant starch | |
| V-500 | 15% vital wheat gluten, 60% resistant | 25% |
| | starch | |
| V-600 | 14% vital wheat gluten, 56% resistant | 30% |
| | starch | |
| V-700 | 13% vital wheat gluten, 52% resistant | 35% |
| | starch | |
| V-800 | 12% vital wheat gluten, 48% resistant | 40% |
| | starch | |
| PV-500 | 2% wheat protein isolate, 14.6% vital | 25% |
| | wheat gluten, 58.4% resistant starch | |
| PV-600 | 2% wheat protein isolate, 13.6% vital | 30% |
| | wheat gluten, 54.4% resistant starch | |
| PV-700 | 2% wheat protein isolate, 12.6% vital | 35% |
| | wheat gluten, 50.4% resistant starch | |
| PV-800 | 2% wheat protein isolate, 11.6% vital | 40% |
| | wheat gluten, 46.4% resistant starch | |

The resistant starch used in each of these experiments was MGPI Fibersym 70. The wheat protein isolate used in these experiments was MGPI Pasta Power.

TABLE 4
Spaghetti Color

| Product | Hunter | | | Color | CIE | | |
|---|---|---|---|---|---|---|---|
| Code | L | a | b | Score | L | a | b |
| Control | 53.67 | 3.83 | 23.93 | 7.5 | 60.61 | 4.51 | 40.16 |
| V-800 | 54.15 | 3.15 | 20.83 | 7 | 61.06 | 3.71 | 32.74 |
| V-700 | 54.71 | 3.26 | 20.56 | 7 | 61.60 | 3.82 | 31.94 |
| V-600 | 55.46 | 3.09 | 20.12 | 7 | 62.30 | 3.62 | 30.76 |
| V-500 | 55.94 | 3.03 | 19.81 | 6 | 62.75 | 3.54 | 29.96 |
| P-800 | 59.68 | 2.82 | 22.74 | 7 | 66.23 | 3.22 | 34.50 |
| P-700 | 59.42 | 2.71 | 22.42 | 7 | 65.98 | 3.10 | 33.95 |
| P-600 | 59.83 | 2.76 | 22.07 | 7 | 66.36 | 3.16 | 33.08 |
| P-500 | 60.98 | 2.76 | 21.69 | 7.5 | 67.42 | 3.13 | 31.91 |
| PV-800 | 54.90 | 3.06 | 21.56 | 7 | 61.78 | 3.59 | 33.99 |
| PV-700 | 54.79 | 3.19 | 21.14 | 7 | 61.67 | 3.75 | 32.38 |
| PV-600 | 55.18 | 3.27 | 20.86 | 7 | 62.04 | 3.83 | 31.37 |
| PV-500 | 55.23 | 3.16 | 20.38 | 7 | 62.08 | 3.69 | 40.16 |

Acceptable color scores between about 6-7.5 were obtained when between about 25-40% of the dry ingredients comprised semolina, with the remaining 60-75% of the dry ingredients being formed of a synthetic flour mixture.

TABLE 5
General Appearance of Spaghetti

| Product | |
|---|---|
| Code | General Appearance |
| Control | uniform |
| V-800 | uniform |
| V-700 | moderate number of hydration specks |
| V-600 | high number of hydration specks |
| V-500 | high number of hydration specks |
| P-800 | moderate number of hydration specks |
| P-700 | scaly appearance |
| P-600 | scaly appearance |
| P-500 | scaly appearance |
| PV-800 | uniform |
| PV-700 | uniform |
| PV-600 | low number of hydration specks |
| PV-500 | low number of hydration specks |

Samples designated as “uniform” or having a “low number of hydration specks are preferred, although those with a “moderate number of hydration specks” may also be considered acceptable.

TABLE 6
Cooking Quality of Spaghetti (Cooking Time = 12 minutes)

| | | Cooked weight, | Firmness, |
|---|---|---|---|
| Product Code | Cooking loss, % | grams | gcm |
| Control | 5.64 | 29.13 | 6.4 |
| V-800 | 3.69 | 22.10 | 6.4 |
| V-700 | 3.35 | 21.37 | 7.5 |
| V-600 | 3.08 | 21.00 | 7.9 |
| V-500 | 2.75 | 20.57 | 7.5 |
| P-800 | 3.76 | 22.10 | 8.0 |
| P-700 | 3.89 | 22.25 | 6.9 |
| P-600 | 3.56 | 21.87 | 6.4 |
| P-500 | 3.61 | 21.29 | 6.5 |
| PV-800 | 3.46 | 21.88 | 7.2 |
| PV-700 | 3.39 | 21.10 | 7.6 |
| PV-600 | 2.93 | 20.97 | 7.8 |
| PV-500 | 2.83 | 20.50 | 7.9 |

Cooked weights of the samples containing 60-75% synthetic flour mixture were between about 20-22 g and firmness values were between about 6.4-8.0 gcm. Both parameters fall within acceptable ranges.

TABLE 7
Cooking Quality of Spaghetti (Optimum Cooking Time)

| | Optimum | | Cooked | |
|---|---|---|---|---|
| Product | cooking time, | Cooking | weight, | Firmness, |
| Code | minutes | loss, % | grams | gcm |
| Control | 11.0 | 5.55 | 28.45 | 7.2 |
| V-800 | 13.5 | 4.40 | 23.80 | 6.1 |
| V-700 | 14.5 | 4.55 | 23.10 | 6.75 |
| V-600 | 15.0 | 3.45 | 22.60 | 6.25 |
| V-500 | 15.5 | 3.25 | 22.55 | 6.9 |
| P-800 | 14.0 | 4.00 | 23.10 | 7.95 |
| P-700 | 13.5 | 4.05 | 22.95 | 7.3 |
| P-600 | 13.5 | 4.00 | 22.95 | 6.1 |
| P-500 | 13.0 | 3.65 | 22.10 | 6.35 |
| PV-800 | 13.0 | 3.60 | 22.40 | 7.1 |
| PV-700 | 14.0 | 3.40 | 22.55 | 7.15 |
| PV-600 | 14.5 | 3.10 | 22.30 | 7.4 |
| PV-500 | 15.0 | 3.00 | 22.05 | 7.3 |

Optimum cooking times ranged from about 13-15 minutes and produced pasta products with cooked weights at least double their pre-cooked weights and firmness values between about 6 and 8.

### Example 4

Composition of Synthetic Flour Mixture and
Semolina for Spaghetti Making

| Product Code | Synthetic Flour Mixture | Semolina |
|---|---|---|
| Control | 0% | 100% |
| 841 | 1.8% wheat protein isolate, 8.9% | 89.3% |
| | resistant starch | |
| 842 | 1.8% wheat protein isolate, 8.9% | 89.3% |
| | resistant starch | |
| 843 | 1.8% wheat protein isolate, 8.9% | 89.3% |
| | resistant starch | |
| 844 | 1.8% wheat protein isolate, 8.9% | 89.3% |
| | resistant starch | |
| 845 | 1.8% wheat protein isolate, 8.9% | 89.3% |
| | resistant starch | |
| 846 | 1.8% wheat protein isolate, 8.9% | 89.3% |
| | resistant starch | |
| 847 | 1.8% wheat protein isolate, 8.9% raw | 89.3% |
| | wheat starch | |
| 601 | 10% wheat protein isolate, 20% | 40.0% |
| | devitalized wheat gluten, 30% | |
| | resistant starch | |
| 602 | 12.5% wheat protein isolate, 17.5% | 40.0% |
| | devitalized wheat gluten, 30% | |
| | resistant starch | |
| 603 | 11.25% wheat protein isolate, 18.75% | 40.0% |
| | devitalized wheat gluten, 30% | |
| | resistant starch | |
| 604 | 8.75% wheat protein isolate, 21.25% | 40.0% |
| | devitalized wheat gluten, 30% | |
| | resistant starch | |
| 605 | 7.5% wheat protein isolate, 22.5% | 40.0% |
| | devitalized wheat gluten, 30% | |
| | resistant starch | |
| 351 | 25% wheat protein isolate, 29% | 20.0% |
| | devitalized wheat gluten, 10% | |
| | resistant starch, | |
| | 16% wheat fiber | |
| 352 | 20% wheat protein isolate, 34% | 20.0% |
| | devitalized wheat gluten, 10% | |
| | resistant starch, | |
| | 16% wheat fiber | |
| 353 | 25% wheat protein isolate, 29% | 15.0% |
| | devitalized wheat gluten, 15% | |
| | resistant starch, | |
| | 16% wheat fiber | |

The resistant starch used in experiments 351-353, 601-605 and 841 was Fibersym 70. The resistant starch used in experiment 842 was Novelose 260, a 60% TDF, RS₂ type resistant starch manufactured by National Starch & Chemical Company from high-amylose corn starch. The resistant starch used in experiment 843 was Hi-Maize 1043, which has the same properties and origin as Novelose 260. The resistant starch used in experiment 844 was Novelose 240, a 40% TDF, RS₂ type resistant starch manufactured by National Starch & Chemical Company from high-amylose corn starch. The resistant starch used in experiment 845 was Novelose 330, a 30% TDF, RS₃ type resistant starch manufactured by National Starch & Chemical Company from high-amylose corn starch. The resistant starch used in experiment 846 was CrystaLean, a 30% TDF, RS₃ type resistant starch manufactured by Opta® Food Ingredients, Inc. from high-amylose corn starch.

The wheat protein isolate used in all experiments was MGPI Pasta Power. The raw wheat starch used in experiment 847 was Midsol 50, which is manufactured by MGP Ingredients. The devitalized wheat protein used in experiments 351-353 and 601-605 was Wheatex 16, an extruded or textured wheat protein manufactured by MGP Ingredients. The wheat fiber used in experiments 351-353 was Vitacel wheat fiber.

TABLE 8
Spaghetti Color

| Product | Dry spaghetti color | | | Color | Hunter | | |
|---|---|---|---|---|---|---|---|
| Code | L | a | b | Score | L | a | b |
| Control | 59.54 | 5.04 | 37.77 | 7.5 | 52.55 | 4.26 | 22.69 |
| 841 | 60.31 | 4.54 | 38.41 | 7.5 | 53.36 | 3.85 | 23.14 |
| 842 | 60.36 | 4.33 | 38.22 | 7.5 | 53.41 | 3.67 | 23.07 |
| 843 | 59.91 | 4.64 | 38.24 | 7.5 | 52.93 | 3.93 | 22.97 |
| 844 | 59.67 | 4.57 | 37.99 | 7.5 | 52.68 | 3.86 | 22.81 |
| 845 | 59.34 | 4.60 | 37.67 | 7.5 | 52.34 | 3.88 | 22.60 |
| 846 | 59.29 | 4.69 | 37.27 | 7.5 | 52.29 | 3.95 | 22.41 |
| 847 | 59.49 | 4.87 | 37.08 | 6.0 | 52.50 | 4.11 | 22.39 |
| 601 | 54.15 | 8.69 | 35.59 | 5.5 | 47.03 | 7.18 | 20.51 |
| 602 | 54.21 | 8.56 | 35.80 | 5.5 | 47.09 | 7.07 | 20.60 |
| 603 | 54.08 | 8.49 | 35.41 | 5.5 | 46.96 | 7.01 | 20.42 |
| 604 | 53.80 | 8.82 | 35.31 | 5.5 | 46.67 | 7.27 | 20.31 |
| 605 | 53.72 | 8.98 | 35.50 | 5.5 | 46.59 | 7.41 | 20.37 |
| 351 | 51.29 | 9.16 | 30.89 | 4.5 | 44.18 | 7.44 | 17.97 |
| 352 | 51.50 | 9.30 | 30.73 | 4.5 | 44.39 | 7.56 | 17.95 |
| 353 | 50.72 | 9.38 | 30.43 | 4.0 | 43.62 | 7.59 | 17.67 |

Samples 841-847 containing about 90% semolina and about 10% synthetic starch mixture produced the best color scores. Sample 601-605 containing about 40% semolina, 30% resistant starch and 30% protein produced color scores near the preferred range of 6-9.

TABLE 9
General Appearance of Spaghetti

| Product | |
|---|---|
| Code | General Appearance |
| Control | uniform, smooth surface |
| 841 | uniform, smooth surface |
| 842 | uniform, smooth surface |
| 843 | uniform, smooth surface |
| 844 | uniform, smooth surface |
| 845 | uniform, smooth surface |
| 846 | uniform, smooth surface |
| 847 | uniform, smooth surface |
| 601 | dull with a rough surface |
| 602 | dull with a rough surface |
| 603 | dull with a rough surface |
| 604 | dull with a rough surface |
| 605 | dull with a rough surface |
| 351 | very dull with a very rough surface |
| 352 | very dull with a very rough surface |
| 353 | very dull with a very rough surface |

Samples 841-847 provided uniform products with smooth surfaces. Samples 601-605 provided dull products with rough surfaces. Samples 351-353 provided very dull products with very rough surfaces.

TABLE 10
Cooking Quality of Spaghetti (Optimum Cooking Time)

| | Optimum | | Cooked | |
|---|---|---|---|---|
| Product | cooking time, | | weight, | Firmness, |
| Code | minutes | Cooking loss, % | grams | gcm |
| Control | 10.2 | 6.1 | 27.9 | 6.1 |
| 841 | 11.1 | 5.9 | 27.6 | 6.1 |
| 842 | 10.3 | 5.6 | 27.3 | 6.2 |
| 843 | 10.2 | 5.4 | 27.1 | 6.3 |
| 844 | 10.2 | 6.0 | 27.5 | 6.1 |
| 845 | 10.3 | 6.0 | 27.5 | 6.4 |
| 846 | 10.2 | 6.1 | 27.4 | 5.9 |
| 847 | 10.0 | 5.5 | 28.4 | 5.6 |
| 601 | 13.4 | 5.9 | 22.7 | 13.8 |
| 602 | 14.0 | 5.5 | 22.6 | 14.9 |
| 603 | 14.2 | 5.3 | 23.1 | 15.0 |
| 604 | 13.7 | 5.9 | 22.8 | 13.6 |
| 605 | 13.4 | 6.3 | 23.0 | 12.5 |
| 351 | 18.3 | 6.6 | 21.7 | 23.2 |
| 352 | 18.0 | 6.3 | 21.6 | 18.3 |
| 353 | 18.3 | 6.0 | 21.4 | 24.6 |

Samples 841-847 were cooked for about 10 minutes and provided pasta products with cooked weights of about 27 grams and firmness near 6 gcm. Other samples produced excessively firm products, even with extensive cooking times.

### Example 5

### Composition of Synthetic Flour Mixture and Flour for White Salted Noodle Making

TABLE 11
White Salted Noodle Formulations

| Ingredients | 1 | 2 | 3 | 4 | 5 |
|---|---|---|---|---|---|
| Flour | 100 | 90 | 70 | 50 | 30 |
| Resistant starch/wheat | 0 | 10 | 30 | 50 | 70 |
| protein isolate blend | | | | | |
| Water | 28 | 29 | 30 | 32 | 34 |
| Salt | 1.5 | 1.5 | 1.5 | 1.5 | 1.5 |

The resistant starch used in this Example was Fibersym 70. The wheat protein isolate used in this Example was MGPI Pasta Power.

TABLE 12
White Salted Noodle Sheet Color After 0 and 24 Hours

| Level of | | | | | | |
|---|---|---|---|---|---|---|
| resistant | | | | | | |
| starch/wheat | | | | | | |
| protein isolate | 0 Hours | | | 24 Hours | | |
| blend | L | a | b | L | a | b |
| 0% | 81.31 | 0.01 | 17.06 | 71.00 | 0.83 | 21.91 |
| 10% | 81.67 | 0.04 | 16.59 | 70.21 | 0.94 | 22.05 |
| 30% | 80.96 | 0.11 | 17.54 | 71.40 | 0.94 | 21.84 |
| 50% | 82.29 | −0.01 | 16.55 | 74.03 | 0.88 | 20.85 |
| 70% | 82.96 | 0.00 | 15.91 | 76.29 | 0.88 | 19.43 |

In white salted noodles, lightness tends to increase and yellowness tends to decrease as the percent substitution of Fibersym 70/Pasta Power blend increases.

TABLE 13
Percent Water Absorption After Cooking White Salted Noodles

| Level of resistant starch/wheat | |
|---|---|
| protein isolate blend | Water Absorption |
| 0% | 116.9% |
| 10% | 116.5% |
| 30% | 106.2% |
| 50% | 105.8% |
| 70% | 93.0% |

Percent water absorption after cooking decreased as the synthetic flour mixture substitution increased. For white salted noodles, 10% and 30% substitution produced noodles with acceptable texture (bite, springiness, and mouthfeel) after cooking.

### Example 6

### Composition of Synthetic Flour Mixture and Flour for Chuka-Men Noodle Making

TABLE 14
Chuka-Men Noodle Formulations

| Ingredients | 1 | 2 | 3 | 4 | 5 |
|---|---|---|---|---|---|
| Wheat Flour | 100 | 90 | 70 | 50 | 30 |
| Resistant starch/wheat | 0 | 10 | 30 | 50 | 70 |
| protein isolate blend | | | | | |
| Water | 32 | 33 | 34 | 36 | 38 |
| Salt | 1 | 1 | 1 | 1 | 1 |
| Potassium carbonate | 0.6 | 0.6 | 0.6 | 0.6 | 0.6 |
| Sodium carbonate | 0.4 | 0.4 | 0.4 | 0.4 | 0.4 |

The resistant starch used in this Example was Fibersym 70. The wheat protein isolate used in this Example was MGPI Pasta Power.

TABLE 15
Chuka-Men Noodle Sheet Color After 0 and 24 Hours

| Level of | | | | | | |
|---|---|---|---|---|---|---|
| resistant | | | | | | |
| starch/wheat | | | | | | |
| protein isolate | 0 Hours | | | 24 Hours | | |
| blend | L | a | b | L | a | b |
| 0% | 83.02 | −1.94 | 20.85 | 75.66 | −1.71 | 23.98 |
| 10% | 82.49 | −1.65 | 20.26 | 75.34 | −1.23 | 23.76 |
| 30% | 81.30 | −1.07 | 19.61 | 74.45 | −0.54 | 22.93 |
| 50% | 80.36 | −0.58 | 18.83 | 73.84 | −0.01 | 21.00 |
| 70% | 81.57 | −0.54 | 17.67 | 75.64 | 0.12 | 20.27 |

Yellowness was acceptable for chuka-men noodles at 10% substitution but tends to decrease as the level of substitution increases from 30-70%.

TABLE 16
Percent Water Absorption After Cooking Chuka-Men Noodles

| Level of resistant starch/wheat | |
|---|---|
| protein isolate blend | Water Absorption |
| 0% | 107.9% |
| 10% | 104.7% |
| 30% | 97.4% |
| 50% | 93.7% |
| 70% | 91.0% |

Percent water absorption after cooking decreased as the synthetic flour mixture substitution increased. For chuka-men noodles, 10% and 30% substitution produced noodles with acceptable texture (bite, springiness, and mouthfeel) after cooking.

### Example 7

### Composition of Synthetic Flour Mixture and Flour for Instant Fried Noodle Making

TABLE 17
Instant Fried Noodle Formulations

| Ingredients | 1 | 2 | 3 | 4 | 5 |
|---|---|---|---|---|---|
| Wheat Flour | 100 | 90 | 70 | 50 | 30 |
| Resistant starch/wheat | 0 | 10 | 30 | 50 | 70 |
| protein isolate blend | | | | | |
| Water | 33 | 34 | 35 | 37 | 38 |
| Salt | 1.5 | 1.5 | 1.5 | 1.5 | 1.5 |
| Potassium carbonate | 0.1 | 0.1 | 0.1 | 0.1 | 0.1 |
| Sodium carbonate | 0.1 | 0.1 | 0.1 | 0.1 | 0.1 |
| Guar gum | 0.2 | 0.2 | 0.2 | 0.2 | 0.2 |
| Phosphate salt | 0.1 | 0.1 | 0.1 | 0.1 | 0.1 |

The resistant starch used in this Example was Fibersym 70. The wheat protein isolate used in this Example was MGPI Pasta Power.

TABLE 18
Instant Fried Noodle Sheet Color After 0 and 24 Hours

| Level of | | | | | | |
|---|---|---|---|---|---|---|
| resistant | | | | | | |
| starch/wheat | | | | | | |
| protein isolate | 0 Hours | | | 24 Hours | | |
| blend | L | a | b | L | a | b |
| 0% | 79.27 | −0.55 | 19.79 | 62.80 | 0.15 | 18.94 |
| 10% | 77.84 | −0.17 | 20.49 | 62.13 | 0.34 | 18.88 |
| 30% | 78.94 | −0.10 | 19.92 | 65.47 | 0.65 | 19.97 |
| 50% | 80.37 | −0.12 | 19.33 | 69.21 | 0.88 | 21.05 |
| 70% | 81.05 | −0.09 | 19.25 | 73.10 | 0.96 | 21.42 |

All instant fried noodle formulas with different levels of synthetic flour mixture substitution have acceptable lightness and yellowness.

TABLE 19
Percent Water Absorption After Cooking Instant Fried Noodles

| Level of resistant starch/wheat | |
|---|---|
| protein isolate blend | Water Absorption |
| 0% | 132.9% |
| 10% | 128.8% |
| 30% | 114.7% |
| 50% | 105.8% |
| 70% | 101.9% |

Percent water absorption after cooking decreased as the synthetic flour mixture substitution increased. The 10% and 30% synthetic flour mixture substitution yielded instant fried noodles with acceptable texture after cooking. The 50% level was judged fairly acceptable.

Changes may be made in the above compositions and methods without departing from the invention described in the Summary and defined by the following claims. It should thus be noted that the matter contained in the above description or shown in the accompanying drawings should be interpreted as illustrative and not limiting.

All references cited are incorporated by reference herein.

We claim:

1. A high-fiber, high-protein pasta, said pasta comprising:
a resistant starch having a total dietary fiber content between about 10% and about 70%;
a protein source selected from the group consisting of gliadin, glutenin, a wheat protein isolate, a wheat protein concentrate, a devitalized wheat gluten, a fractionated wheat protein product, a deamidated wheat gluten product, a hydrolyzed wheat protein product, or a mixture thereof; and
semolina.

2. The pasta of claim 1 wherein the resistant starch is present in an amount from about 8.8% to about 80%.

3. The pasta of claim 1 wherein the resistant starch is present in an amount from about 8.8% to about 60%.

4. The pasta of claim 1 wherein the protein source is present in an amount from about 1.5% to about 30%.

5. The pasta of claim 1 wherein the protein source is present in an amount from about 1.5% to about 15%.

6. The pasta of claim 1 wherein the semolina is present in an amount from about 25% to about 90%.

7. The pasta of claim 1, said pasta having a firmness greater than about 6 gcm.

8. The pasta of claim 1, said pasta having a color score in a range of between about 6 and about 9.

9. The pasta of claim 1, said pasta having a color score in a range of between about 7 and about 9.

10. A high-fiber, high-protein noodle, said noodle comprising:
a resistant starch having a total dietary fiber content between about 10% and about 70%;
a protein source selected from the group consisting of gliadin, glutenin, a wheat protein isolate, a wheat protein concentrate, a devitalized wheat gluten, a fractionated wheat protein product, a deamidated wheat gluten product, a hydrolyzed wheat protein product, or a mixture thereof; and
wheat flour.

11. The noodle of claim 10 wherein the resistant starch is present in an amount from about 8.4% to about 42%.

12. The noodle of claim 10 wherein the protein source is present in an amount from about 1.6% to about 8%.

13. The noodle of claim 10 wherein the wheat flour is present in an amount from about 50% to about 90%.

14. An improved method of producing pasta comprising substituting a synthetic flour mixture for a portion of semolina.

15. The method of claim 14 wherein the synthetic flour mixture is substituted for about 10% to about 75% of the semolina.

16. The method of claim 14 wherein the synthetic flour mixture comprises a resistant starch and a protein source.

17. The method of claim 16 wherein the resistant starch has a total dietary fiber content between about 10% and about 70% and the protein source is selected from the group consisting of gliadin, glutenin, a wheat protein isolate, a wheat protein concentrate, a devitalized wheat gluten, a fractionated wheat protein product, a deamidated wheat gluten product, a hydrolyzed wheat protein product, or a mixture thereof.

18. An improved method of producing noodles comprising substituting a synthetic flour mixture for a portion of wheat flour.

19. The method of claim 18 wherein the synthetic flour mixture is substituted for about 10% to about 50% of the wheat flour.

20. The method of claim 18 wherein the synthetic flour mixture comprises a resistant starch source and a protein source.
